(19) United States
(12) Patent Application Publication
(10) Pub. No.: US 2011/0194107 A1
(43) Pub. Date: Aug. 11, 2011

(54) SYSTEM AND METHOD FOR MONITORING STRUCTURES

(75) Inventors: Arthur H. HARTOG, Winchester (GB); Andrew STRONG, Romsey (GB); Graeme HILTON, Southampton (GB); Gareth P. LEES, Southampton (GB)

(73) Assignee: SCHLUMBERGER TECHNOLOGY CORPORATION, SUGAR LAND, TX (US)

(21) Appl. No.: 13/089,188

(22) Filed: Apr. 18, 2011

Related U.S. Application Data
(62) Division of application No. 12/282,191, filed on Dec. 9, 2008, now abandoned.

(30) Foreign Application Priority Data
Mar. 14, 2006 (GB) 0605066.0
Jan. 26, 2007 (GB) 0701484.4

(51) Int. Cl. G01J 3/44; G01N 21/00; G01J 3/00

(52) U.S. Cl. 356/301; 356/237.1; 356/300

(57) ABSTRACT

A technique facilitates the monitoring of elongate structures. An elongate structure is combined with an optical fiber deployed along the structure. An interrogation system is operatively joined with the optical fiber to input and monitor optical signals to determine any changes in parameters related to the structure.

### CROSS-REFERENCE TO RELATED APPLICATIONS

This application is a Divisional of U.S. application Ser. No. 12/282,191, filed Dec. 9, 2008, entitled “System And Method For Monitoring Structures”, which is a 371 International application of PCT/GB2007/000595, filed Feb. 22, 2007, which claims priority to GB application number 0605066.0, filed Mar. 14, 2006, and GB application number 0701484.8, filed Jan. 26, 2007, incorporated herein by reference.

### BACKGROUND OF THE INVENTION

A variety of structures, e.g. pipelines, can extend over substantial distances and be relatively inaccessible, creating difficulties in monitoring such structures. For example, high-pressure gas pipelines can extend across inhospitable terrain that creates risks with respect to maintaining the integrity of the pipe. One risk is from ground movement, e.g. ground movement from landslides or seismic events, which can strain the pipeline beyond its design load. Additionally, there are risks from human intervention, including malicious acts, such as sabotage or theft of contents, or inadvertent acts, such as operation of earth moving equipment proximate the pipeline. Pipelines also can be susceptible to leaks caused by a variety of factors.

With many types of pipelines or other elongate structures, the measurement of parameters indicative of problems or potential problems is difficult. For example, the measurement of strain, temperature, and other indicative parameters can be difficult over substantial distances and/or through inhospitable terrain. Pipelines, for example, can be located in rugged terrain, underground, or in subsea locations that inhibit the monitoring of parameters throughout the length of the structure.

### BRIEF SUMMARY OF THE INVENTION

In general, the present invention provides a system and a methodology for monitoring structures, such as pipelines, that can extend over a substantial distance. The system and methodology combines the structure with an optical fiber that may be in the form of a fiber optic cable deployed along the structure. An interrogation system is operatively joined with the optical fiber to input and monitor optical signals to determine any changes in parameters related to the structure. Changes in parameters can be indicative of problems or potential problems related to the integrity of the structure.

### BRIEF DESCRIPTION OF THE DRAWINGS

Certain embodiments of the invention will hereafter be described with reference to the accompanying drawings, wherein like reference numerals denote like elements, and:

FIG. 1 is a schematic view of a system for monitoring a structure, according to an embodiment of the present invention;

FIG. 2 is a diagrammatic representation of a processor-based control system that can be used to carry out all or part of the methodology related to monitoring of the structure, according to an embodiment of the present invention;

FIG. 3 is a cross-sectional view of an embodiment of an elongate structure combined with an optical fiber, according to an embodiment of the present invention;

FIG. 4 is a view similar to that of FIG. 3, but showing another example of the system, according to an alternate embodiment of the present invention;

FIG. 5 is a view similar to that of FIG. 3, but showing another example of the system, according to an alternate embodiment of the present invention;

FIG. 6 is a cross-sectional view of one embodiment of a fiber optic cable that can be used with the system for monitoring, according to an embodiment of the present invention;

FIG. 7 is a cross-sectional view of another example of a fiber optic cable that can be used with the system for monitoring, according to an alternate embodiment of the present invention;

FIG. 8 is a schematic illustration of structure-related parameters under normal conditions, according to an embodiment of the present invention;

FIG. 9 is a schematic illustration of structure-related parameters indicating a potential problem associated with the structure, according to an embodiment of the present invention;

FIG. 10 is a schematic illustration of structure-related parameters indicating damage to the integrity of the structure, according to an embodiment of the present invention; and

FIG. 11 is a flowchart illustrating an embodiment of the methodology that can be used to implement monitoring of a structure, according to an embodiment of the present invention.

### DETAILED DESCRIPTION OF THE INVENTION

In the following description, numerous details are set forth to provide an understanding of the present invention. However, it will be understood by those of ordinary skill in the art that the present invention may be practiced without these details and that numerous variations or modifications from the described embodiments may be possible.

The present invention relates to a system and methodology for monitoring parameters along the length of elongate structures to determine problems or potential problems with the structures. For example, the system and methodology can be used to provide an indication of a problem or a potential problem with a pipeline or a power cable. Examples include the monitoring and detection of leaks and/or disturbances with pipelines that run through difficult terrain or through substantially inaccessible environments, e.g. pipelines buried within the earth or routed through subsea environments. The technique can also be used with subsea energy cables where the maximum capacity depends on the temperature of the cable and its environment. By observing measurands related to certain parameters, such as temperature, strain, and disturbance, the condition of the structure can be monitored.

In many applications, the monitoring of temperature, static strain, and transient strain, e.g. rapid fluctuations in the strain, is useful in obtaining indications of problems or potential problems with the structure. For example, the detection of localized temperature changes along a pipeline can be indicative of a leak. The monitoring of ground temperature also can be of further interest to an operator, because the freezing/thawing cycles can be tracked and any resultant problems relating to unusual conditions can be better anticipated. Monitoring the distribution of strain along the structure enables the detection of ground movement due to, for example, landslides, seismic events, and third party interference, e.g. the use of earth moving equipment proximate a pipeline. In other applications, the monitoring of temperature within the thermal insulation of a subsea flowline can reveal conditions conducive to the formation of solids, such as asphaltenes, waxes or hydrates. Changes in the strain profile can also indicate a pressure drop caused by the buildup of solids. Additionally, the detection of dynamic strain can reveal the existence of slugging in the flowline, as well as externally induced disturbances.

Detection and monitoring of the parameters over the length of a structure can be achieved by deploying one or more optical fibers along the structure. An appropriate optical signal is input and used to determine parameter changes indicative of a problem or potential problem with the elongate structure. For example, combining the observance of Brillouin backscatter and coherent Rayleigh noise can be used to detect and monitor a variety of parameters along the structure, e.g. pipeline. For example, Brillouin backscatter can be used for the monitoring of generally slow changing parameters, including temperature and strain. Coherent Rayleigh noise can be used for the monitoring of generally fast changing parameters, such as the measurement of strain transients, e.g. dynamic changes, resulting from third party interference events or natural phenomena.

The optical fiber may be in the form of a fiber optic cable containing one or more optical fibers that are probed, e.g. pulsed with laser light, to measure the distribution of, for example, temperature, strain, and dynamic strain along the one or more fibers. The parameters are detected and monitored based on at least the Brillouin frequency shift and the self-interference properties of Rayleigh backscatter when measured with a coherent light source. The intensity of the Brillouin backscatter may also be used. In general, a broadband source may also be employed in the further measurement of the Rayleigh backscatter to acquire a signal that is representative of the attenuation profile of the fiber without temperature or strain sensitivity.

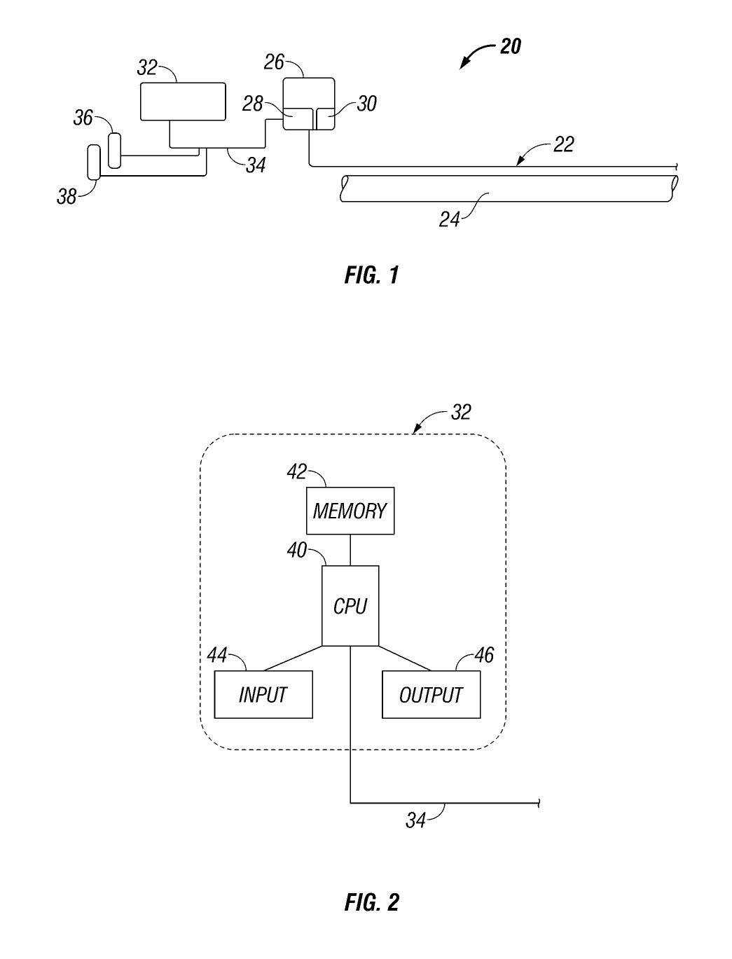

Referring generally to FIG. 1, a system 20 is illustrated as an example of a variety of system configurations that can be used in distributed monitoring of parameters along an elongate structure. In this embodiment, system 20 comprises a sensing cable 22, having one or more optical fibers, deployed along an elongate structure 24. The sensing cable 22 may also include any necessary boxes or additional cable equipment required for splices or other cable connections. Also, the elongate structure 24 may comprise a pipeline, a power cable, or another type of elongate structure for which monitoring is desired.

The system 20 comprises an interrogation unit 26 operatively coupled to sensing cable 22 and used to determine the parameter profile of, for example, temperature, strain, optical attenuation, and dynamic strain along the sensing cable 22. Changes in the profile can be indicative of a problem or a potential problem concerning the elongate structure 24. Interrogation unit 26 may comprise a laser 28 for providing an optical signal in the form of coherent light pulses along the one or more optical fibers of sensing cable 22. In one embodiment, interrogation unit 26 also comprises one or more optical time domain reflectometers configured to measure at least a narrow-band Rayleigh backscatter signal and the Brillouin spectrum along the one or more optical fibers of sensing cable 22. In one embodiment, the Brillouin spectrum is obtained from spontaneous Brillouin scattering. Also, a broadband Rayleigh backscatter signal may be acquired by interrogation unit 26. In another embodiment, the spontaneous Raman backscatter may also be acquired.

A processing unit 32 is coupled to interrogation unit 26 and is used to convert the data measured along sensing cable 22 into information about the state of elongate structure 24. Processing unit 32 may be combined with interrogation unit 26 or coupled to interrogation unit 26 through a communication link 34, such as a network. Additionally, processing unit 32 may be part of a control center, or the processed information can be relayed to a separate control center through, for example, network 34. Also, processing unit 32 may be communicatively coupled with one or more additional sources 36, 38 via, for example, network 34. Sources 36 and 38 provide additional inputs to processing unit 32, such as existing weather information, weather forecast information, satellite imagery, data from geological and seismic maps, and seismic recording station information, or information on operating characteristics of the elongate structure (e.g. flow rate in the case of a pipeline or current in the case of an energy cable).

Although many types of processing units can be used in system 20, one example of a suitable type of processing system is illustrated diagrammatically in FIG. 2. In this embodiment, processing unit 32 comprises a control system in the form of a computer-based system having a central processing unit (CPU) 40. CPU 40 may be operatively coupled to interrogation unit 26 and potentially to other systems, including data sources 36 and 38. CPU 40 may comprise a memory 42, an input device 44, and an output device 46. Memory 42 enables, for example, the archiving of data and the running of algorithms for identifying predetermined types of incidents based on current data and historical data values of the monitored parameters. Input device 44 may comprise a variety of devices, such as a keyboard, mouse, voice-recognition unit, touchscreen, other input devices, or combinations of such devices. Output device 46 may comprise a visual and/or audio output device, such as a monitor having a graphical user interface. It also should be noted that the processing of the information from sensing cable 22 and interrogation unit 26 may be done on a single device or multiple devices at the system location, at a local control center location, at remote locations, or at multiple locations.

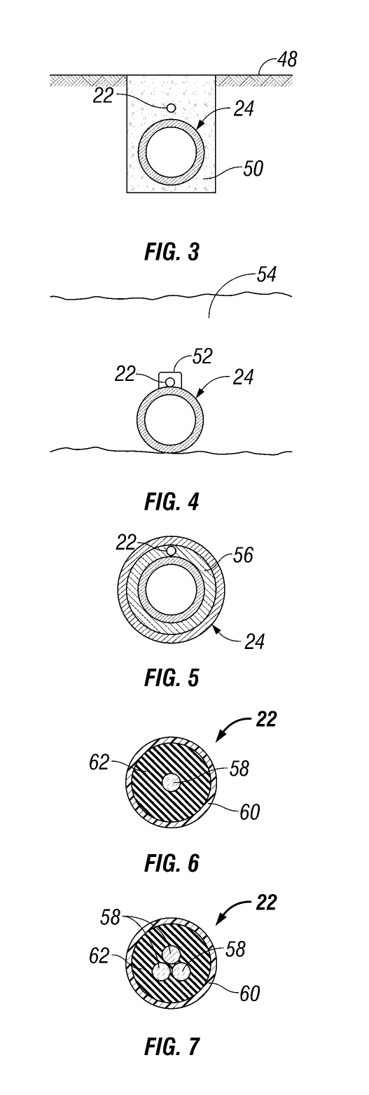

Referring generally to FIGS. 3, 4, and 5, examples of elongate structure 24 and fiber optic sensing cable 22 are illustrated. In FIG. 3, the elongate structure 24 comprises a pipeline buried beneath a surface 48 of the earth. The pipeline 24 may be deployed and covered within a trench 50 formed in the ground. Sensing cable 22 is laid proximate pipeline 24 and routed generally longitudinally along pipeline 24. In this environment, the fiber optic sensing cable 22 is spaced a slight distance from pipeline 24. In other embodiments, however, fiber optic sensing cable 22 can be placed in contact with the elongate structure 24, e.g. a pipeline, as illustrated in FIG. 4. The cable 22 can be attached to pipeline 24 via appropriate fastening systems, such as brackets 52 or adhesives. In the example illustrated in FIG. 4, elongate structure 24 is a subsea structure, such as a subsea pipeline or power cable, located in a body of water 54. In other embodiments, sensing cable 22 can be disposed at least partially within a wall section 56 of the elongate structure 24, as illustrated in FIG. 5. By way of example, wall section 56 may comprise a layer of insulation surrounding a pipe, and fiber optic cable 22 can be disposed partially or fully within the insulation forming wall section 56. Alternatively, fiber optic cable 22 may be disposed between concentric pipes in a pipe-in-pipe construction.

The actual design and configuration of fiber optic sensing cable 22 may vary according to the specific monitoring application. Examples of fiber optic sensing cable designs that include at least one optical fiber are illustrated in FIGS. 6 and 7. Referring first to FIG. 6, sensing cable 22 comprises one optical fiber 58 that is a single-mode optical fiber. Optical fiber 58 may be designed to have a negative chromatic dispersion coefficient at the operating wavelengths of the interrogation unit 26. In other embodiments, however, multiple optical fibers 58 are provided to allocate measurement and monitoring of parameters to separate fibers, as illustrated in FIG. 7. For example, the measurement of temperature, strain, and/or dynamic strain can be allocated to separate optical fibers 58. In other applications, some of the fibers 58 or additional fibers 58 can be dedicated to communications or the carrying of power signals to remote optical units along the elongate structure 24.

The fiber optic sensing cable 22 is designed such that strain on the cable is transferred with a known transfer function to at least one optical fiber 58. If there are additional optical fibers within sensing cable 22, the cable can be designed so as not to subject the additional fibers to strain or to have a different strain transfer function with respect to the additional fibers. Accordingly, the cable 22 can be designed to avoid significantly increasing the optical attenuation of the fiber or fibers, while at least one fiber experiences a coupling of actual strain between the cable, e.g. the outer jacket 60 of the cable, and the fiber itself. For the optical fibers 58 that are not strain-coupled, the sensing cable 22 is designed so there is minimal if any coupling between the outer jacket 60 of the cable and the non-strained optical fibers to ensure minimum attenuation. In these applications, the sensing cable 22 can be formed as a loose-tube design capable of transmitting vibration to the fiber without coupling the strain of the outer jacket to those specific optical fibers. However, the strain-coupled fiber or fibers can be coupled to the cable, e.g. to outer jacket 60, by designing the jacket 60 as a tight fitting jacket about the strain-coupled fiber 58. The tight fit can be achieved by an appropriate soft filler material 62 (see FIG. 6) that sufficiently couples the strain of the outer jacket 60 to the strain of optical fiber 58 while effectively cushioning the optical fiber. System 20 can be designed such that all of the one or more fibers are within a single sensing cable 22, or a plurality of sensing cables 22 can be used to carry different types of optical fibers 58 and/or to provide distributed monitoring capabilities along different regions of an elongate structure.

Once a system 20 is deployed in a given environment, the narrow band Rayleigh backscatter measurement can be used to provide information on dynamic changes to the optical fiber 58, such as temperature or strain variations. Shorter term dynamic events can be determined from just a few laser pulses, although often no absolute value can be obtained. The Brillouin spectrum provides information on temperature and strain averaged over a longer time. The combination of a fast, high-resolution measurement of change along the one or more optical fibers combined with a slower measurement of absolute temperature and strain provides system 20 with an ability to discriminate between the events that might otherwise be indistinguishable or that otherwise might give rise to false alarms. The broadband Rayleigh backscatter effectively provides a monitoring function that has a low temperature and strain sensitivity, but is effective at measuring optical fiber attenuation. This functionality enables the use of optical signals in cable 22 to determine damage to the cable itself and also to correct for loss, thus normalizing other signals in a convenient manner.

The intensity and the frequency shift of the Brillouin lines in optical fibers 58 are sensitive to temperature and strain, and the combination of the intensity of the Brillouin backscatter and its frequency shift can be processed via processing unit 32 to provide temperature and strain distribution measurements along the one or more optical fibers 58 and elongate structure 24. Additionally, the temperature and strain response of an optical fiber within fiber optic sensing cable 22 can be adjusted. By embedding an optical fiber in a material having a high expansion coefficient and a large cross-section relative to the fiber, for example, the temperature sensitivity of the fiber can be enhanced through strain induced by thermal expansion of the material in which the fiber is embedded. Conversely, such effects can be minimized by embedding a fiber in a material having a low expansion coefficient, such as a glass/epoxy composite. By using separate frequency shift measurement of two fibers in the same cable, a temperature profile can be deduced by comparing the measurements on each fiber, and the strain effects can be eliminated.

With respect to strain measurement, the coupling of an optical fiber to the cable strain can be varied from being close to the strain of the cable itself to being fully decoupled from the strain of the cable. In some applications, the different measurement methods can be combined to enable independent separation of the temperature and strain measurements, thus minimizing the precision required for measurement of the frequency shift and/or measurement of the intensity in each fiber within sensing cable 22. More generally, if a multi-fiber cable is designed to provide, on each of at least two fibers, temperature and strain coefficients of one measurand (each frequency shift or Brillouin intensity) that result in a well behaved matrix, the results can then be inverted to provide temperature and strain information for the cable. A similar result can be achieved by providing two or more separate cables having linearly independent responses to strain and temperature. Alternatively, additional information can be gained on the temperature profile, e.g. using Raman backscatter combined with the Brillouin backscatter.

System 20 and its processing unit 32 also facilitate the classification of events by enabling the reduction of large amounts of data to specific or critical information useful and comprehensible to a human decision-maker. For example, in some applications, the interrogation unit 26 may be operatively coupled to sensing cables 22 that have substantial length and provide large amounts of data. If, for example, the sensing cable has a length on the order of 100 km and a narrow-band Rayleigh backscatter sampling rate of 1 KHz while the spatial resolution of the system is 10 m, the processing unit 32 processes millions of readings per second. Additionally, this large amount of data may be compared and analyzed with respect to historical data and other data obtained by processing unit 32 to facilitate the making of decisions as to the criticality of a detected event. The processing unit 32 can also be used to compare the detected event with a catalog of stored, known events. It should be noted that the update rate for the static variables may be substantially slower, but still represents a relatively large amount of data. The ability to store processing algorithms and large amounts of data enables system 20 to measure and monitor large amounts of data received over a relatively long length of sensing cable 22. This, in turn, enables monitoring and detection of problematic or potentially problematic events along structures over substantial distances. The system 20 can also apply artificial intelligence for data analysis and decision-making.

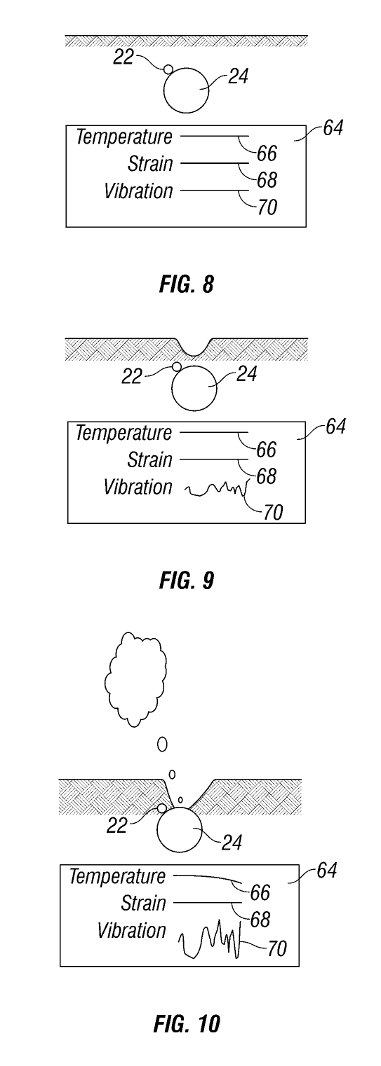

Processing unit 32 can be programmed to provide information on the collected data to a human decision-maker in a variety of formats comprehensible to the human decision-maker. Also, a variety of technologies can be used to present information on the collected data. For example, information related to parameters, such as temperature, strain, and vibration, can be made available graphically through a graphical user interface displayed on output device 46 of processing unit 32. One example is illustrated in FIGS. 8, 9, and 10 in which temperature, strain, and vibration are monitored via sensing cable 22 deployed along a pipeline 24. The temperature, strain and vibration are displayed graphically on a graphical user interface 64.

Under normal operating conditions, the graphical representations of temperature, strain, and vibration do not substantially deviate from normal and are represented by substantially straight graph lines 66, 68 and 70, respectively. If, however, an external influence disturbs the ground surrounding pipeline 24, very strong dynamic changes are detected in the narrow-band Rayleigh signal. This is reflected graphically by substantial deviation in graph line 70, as illustrated in FIG. 9. The external influence can be caused by, for example, digging with earth moving equipment in the vicinity of pipeline 24. The external influence also can be caused by other man-made or natural events resulting in movement of the earth. In a landslide, for example, the strong dynamic changes often are followed by a residual strain localized at the incident. The localized strain would subsequently be reflected in graph line 68.

If pipeline 24 is actually damaged, e.g. through contact with the earth moving equipment, a leak can result. A leak in a gas pipeline, for example, results in a localized temperature drop due to the Joule-Thomson cooling effect. This cooling is detected by the Brillouin backscatter and also via a short term change on the narrow-band Rayleigh signal. The leak also may be accompanied by a localized, high-frequency noise caused by the gas release and possible movement of backfill in the vicinity of the leak. Other changes in temperature can be caused by erosion of the backfill surrounding the pipeline or exposure of the pipeline to other materials or conditions. The changes in the optical signal are processed by processing unit 32 and output via graphical user interface 64 as a change in temperature represented by changes in graph line 66, as illustrated best in FIG. 10. It should be noted, however, that a wide variety of other devices and technologies can be used to convey information to a human decision-maker regarding temperature, strain, vibration, and other parameters related to the integrity of the elongate structure 24.

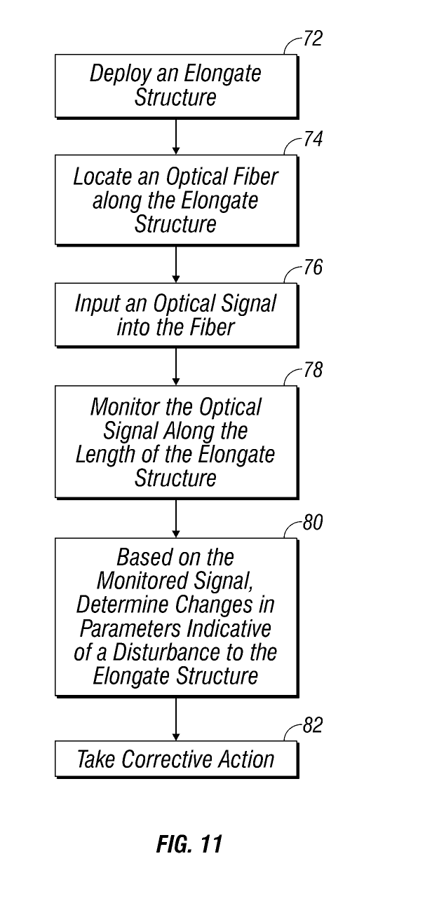

In operation, system 20 is utilized by initially deploying the elongate structure 24, as illustrated by block 72 in the flowchart of FIG. 11. One or more optical fibers 58 are located along the elongate structure 24, e.g. a pipeline, as illustrated by block 74. The one or more optical fibers 58 can be constructed with the elongate structure, laid simultaneously with the elongate structure, or laid subsequently to deployment of the elongate structure. Additionally, the one or more optical fibers can be positioned separate from the elongate structure, in contact with the elongate structure, or at least partially enclosed within the elongate structure. Once the elongate structure and one or more optical fibers are in place, an optical signal is input into one or more of the fibers, as illustrated by block 76. The optical signal is monitored along the length of the elongate structure, as illustrated by block 78. The monitoring can be achieved by the Brillouin and Rayleigh techniques discussed above.

The monitored signal and any changes in the monitored signal can be used to determine changes in parameters indicative of a disturbance or an abnormal event along the elongate structure, as illustrated by block 80. The data received from each fiber optic sensing cable 22 is processed on processing unit 32 and provided to a human decision-maker in a form understandable by the human decision-maker. Appropriate corrective action can then be taken, as illustrated by block 82. In some applications, appropriate actions, such as corrective actions, can be automated and performed by processing unit 32 according to preprogrammed instructions. Appropriate alarms can also be raised via a distributed control/supervisory control and data acquisition system.

System 20 can be used in a wide variety of environments and can incorporate many types of elongate structures. Additionally, the specific components used to construct interrogation unit 26 and processing unit 32 may vary according to the type of application in which they are used, the available technology, and according to various design constraints or parameters. Additionally, the positioning and construction of the fiber optic sensing cable 22 as well as the actual parameters monitored via sensing cable 22 can vary from one application to another.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

1. A method of monitoring an elongate structure, comprising:
deploying a fiber optic cable along the elongate structure; and
using the fiber optic cable to determine a plurality of structure-related parameters indicative of a structural failure or potential structural failure of the elongate structure, wherein using the fiber optic cable to determine the plurality of structure-related parameters comprises combining a fast, high resolution measurement of a change along the fiber optic cable with a slower measurement of absolute temperature and strain along the fiber optic cable.

2. The method as recited in claim 1, wherein the elongate structure is a pipeline.

3. The method as recited in claim 1, wherein the elongate structure is an energy cable.

4. The method as recited in claim 1, wherein using the fiber optic cable to determine a plurality of structure-related parameters comprises monitoring both Brillouin backscatter and coherent Rayleigh noise to determine the plurality of structure-related parameters.

5. The method as recited in claim 4, wherein monitoring Brillouin backscatter comprises measuring strain and temperature along the elongate structure.

6. The method as recited in claim 4, wherein monitoring coherent Rayleigh noise comprises measuring disturbances along the elongate structure.

7. The method as recited in claim 4, wherein using the fiber optic cable to determine a plurality of structure-related parameters further comprises monitoring Raman backscatter.

8. The method as recited in claim 1, wherein the elongate structure is deployed at a subsea location.

9. The method as recited in claim 1, wherein the elongate structure is buried beneath the surface of the earth.

10. The method as recited in claim 1, wherein deploying the fiber optic cable comprises placing the fiber optic cable in contact with the elongate structure.

11. A method, comprising:
locating an optical fiber along an elongate structure;
monitoring an optical signal input through the optical fiber; and
detecting a disturbance to the structure of the elongate structure based on changes in the optical signal, wherein monitoring the optical signal input through the optical fiber comprises:
monitoring the optical signal for both Brillouin backscatter and coherent Rayleigh noise;
using the Brillouin backscatter for the measurement of temperature and strain; and
using the coherent Rayleigh noise for the measurement of strain transients.

12. The method as recited in claim 11, wherein locating the optical fiber along the elongate structure comprises locating the optical fiber along a pipeline.

13. The method as recited in claim 11, wherein locating the optical fiber along the elongate structure comprises locating the optical fiber along an energy cable.

14. The method as recited in claim 11, wherein locating comprises locating the optical fiber along a pipeline positioned beneath the surface of the earth.

15. The method as recited in claim 11, wherein locating comprises locating the optical fiber along a subsea pipeline.
